(19) United States
(12) Patent Application Publication
(10) Pub. No.: US 2017/0114795 A1
(43) Pub. Date: Apr. 27, 2017

(54) COMPOSITE COMPRESSOR VANE OF AN AXIAL TURBINE ENGINE

(71) Applicant: Safran Aero Boosters SA, Herstal (Milmort) (BE)

(72) Inventor: Eric Englebert, Villers-Le-Bouillet (BE)

(21) Appl. No.: 15/210,071

(22) Filed: Jul. 14, 2016

(30) Foreign Application Priority Data
Jul. 22, 2015 (BE) 2015/5469

(51) Int. Cl. F04D 29/54; B64D 27/16; F04D 29/64; F04D 29/32; F04D 29/02

(52) U.S. Cl. CPC F04D 29/542; F04D 29/324; F04D 29/023; F04D 29/644; B64D 27/16

(57) ABSTRACT

A vane of a low pressure compressor of an axial turbine engine. The vane can be connected to the rotor or to the stator. The vane includes an airfoil forming a body in composite material with an organic matrix, and a reinforcing frame. This frame displays a base of a vane intended to be welded to the compressor drum, an upstream portion extending from the base and forming the leading edge of the vane, and a stiffener. The stiffener is situated at a central position of the base and remains enveloped in the airfoil of the vane. In the core, it forms a strip with orifices. The frame also has a cut-out separating the upstream portion from the stiffener, the upstream portion extending from the base along the height of the stiffener. This architecture reduces the mass of the frame, while preserving the general stiffness.

### CROSS-REFERENCE TO RELATED APPLICATIONS

This application claims the benefit, under 35 U.S.C. §119, of BE 2015/5469 filed Jul. 22, 2015, the disclosure of which is incorporated herein by reference in its entirety.

### FIELD

The invention relates to a reinforced vane of a turbine engine. More precisely, the invention relates to the rigidity of a lightened composite vane of an axial turbine engine. The invention also relates to an axial turbine engine, such as a turbojet engine of an aircraft or a turboprop engine of an aircraft.

### BACKGROUND

A turbojet engine ensuring the propulsion of an aircraft must notably respect the constraints of mass, performance and reliability. Its functioning implies several rows of rotor and stator vanes, the rows commonly having more than a hundred vanes. The production and design costs of these vanes weigh heavily on that of the turbojet engine.

In order to satisfy the specifications for the turbojet engine, the vanes must be light and robust, while respecting a predefined geometry. In particular, they must resist erosion. This phenomenon becomes particularly critical in a compressor where the leading edges of vanes suffer ingestions. A compromise taking these constraints into consideration consists of creating a vane whose airfoil forms a body in composite material, and whose leading edge is armoured by a metal insert.

The document FR 3 011 269 A1 discloses an aeronautical engine with guide vanes. A vane has a hybrid structure, with a metal leading edge and a airfoil in composite material. The leading edge has an interior fastening area, and is extended by a downstream rib into the thickness of the composite airfoil. A vane has a metal trailing edge forming a one-piece assembly with the leading edge. This design makes it possible to optimize the strength of the vane, but penalizes its mass. The turbojet engine that accommodates it suffers this weight. In the context of a rotor, such a vane type furthermore penalizes the inertia of the rotor. During functioning, the gyroscopic force makes greater demands on the bearings, and the centrifugal force deforms the rotor.

### SUMMARY

The objective of the invention is to resolve at least one of the problems posed by the prior art. More precisely, the objective of the invention is to reduce the weight of a vane of a turbine engine while preserving its rigidity.

The invention relates to a frame of a vane of a turbine engine, in various instances a vane of a compressor of a turbine engine, the frame being one-piece and including a base of a vane intended to be connected to a support of the turbine engine, and an upstream portion extending from the base and forming a leading edge of the vane. It further includes a stiffener generally situated at a central position of the base, the frame having a cut-out, which separates the upstream portion from the stiffener and which extends from the base along the height of the stiffener. The height can be measured perpendicularly from the base.

According to various advantageous embodiments of the invention, the stiffener extends from the base along the majority of the height of the upstream portion, for example, along the majority of the height of the frame.

According to various advantageous embodiments of the invention, the stiffener has a plurality of through-orifices, the orifices, in various instances, being distributed along its height.

According to various advantageous embodiments of the invention, the stiffener forms a strip, in various instances, of a constant width.

According to various advantageous embodiments of the invention, the stiffener and the upstream portion are generally parallel, they optionally each have a free extremity opposite the base.

According to various advantageous embodiments of the invention, the base is or includes an aerodynamic vane profile, the profile, in various instances, being cambered.

According to various advantageous embodiments of the invention, the base is or includes a fastening platform, which can include a fastening portion extending from the base to opposite the stiffener along the radial direction of the turbine engine.

According to various advantageous embodiments of the invention, the base has a downstream extremity, the stiffener being distanced from the downstream extremity.

According to various advantageous embodiments of the invention, the frame is produced from metal, for example, titanium, in various instances produced by additive manufacturing based on metal, in various instances, as powder.

According to various advantageous embodiments of the invention, the frame is a frame of an axial turbine engine, the leading edge and the stiffener being intended to extend radially through the primary flow.

According to various advantageous embodiments of the invention, the cut-out passes through the frame.

According to various advantageous embodiments of the invention, the stiffener extends along substantially the entire height of the upstream portion.

According to various advantageous embodiments of the invention, the cut-out extends, in various instances, in a continuous manner along substantially the entire height of the stiffener, for example, along substantially the entire height of the upstream portion.

According to various advantageous embodiments of the invention, the stiffener is at a central position of the base along the length of the base and/or along the direction of flow of the fluid in relation to the vane, and/or perpendicular to the leading edge.

According to various advantageous embodiments of the invention, the stiffener is not as wide as the upstream portion.

According to various advantageous embodiments of the invention, the orifices have profiles as ellipses, the main elongation of the ellipses being perpendicular to the base.

According to various advantageous embodiments of the invention, the density of the material of the frame is greater than or equal to 2.00, for example, greater than or equal to 4.00.

According to various advantageous embodiments of the invention, the frame is integral, in various instances, integrally cast or integrally manufactured, for instance by an additive manufacturing process with powder.

The invention further relates to a vane of a turbine engine, for example, a vane of a compressor, the vane including a frame, wherein the frame conforms to the invention, the vane, in various instances, includes an airfoil intended to divert circumferentially a flow of the turbine engine, the airfoil including a body enveloping the stiffener.

The one-piece aspect is not indispensable to the invention in connection with the vane, the stiffener can be added thereto, for instance fastened or embedded.

According to various advantageous embodiments of the invention, the upstream portion extends along the majority of the height of the vane, and in various instances along the majority of the thickness of the vane.

According to various advantageous embodiments of the invention, the body includes a polymer material and/or a composite material with an organic matrix.

According to various advantageous embodiments of the invention, the vane includes a trailing edge, an intrados surface and an extrados surface, which extend from the leading edge to the trailing edge, the body including an envelope forming the intrados surface and the extrados surface, the trailing edge can be formed by the body.

According to various advantageous embodiments of the invention, the vane includes a free extremity opposite the base, the stiffener being distanced from the free extremity.

According to various advantageous embodiments of the invention, the body forms an upstream block isolating the upstream portion from the stiffener, the block being continuous along the entire height of the airfoil.

According to various advantageous embodiments of the invention, the upstream portion has a groove turned towards the stiffener, the groove being filled by the body.

According to various advantageous embodiments of the invention, the upstream portion essentially forms a foil of a constant thickness, the foil having an upstream face forming the leading edge and a downstream face covered by the body.

According to various advantageous embodiments of the invention, the vane includes a trailing edge, the body forms a downstream block isolating the trailing edge from the stiffener, the block being continuous along the entire length of the trailing edge.

According to various advantageous embodiments of the invention, the body has a radial stack of aerodynamic profiles of vanes with mean camber lines, at least one or each of the mean camber lines being placed in the thickness of the stiffener.

According to various advantageous embodiments of the invention, the stiffener is situated at the centre of the chord of the vane.

According to various advantageous embodiments of the invention, the stiffener is distanced from the intrados surface and from the extrados surface, in various instances, in the middle between these surfaces.

According to various advantageous embodiments of the invention, the upstream portion extends along substantially the entire height of the vane, and in various instances along substantially the entire thickness of the vane.

According to various advantageous embodiments of the invention, the base forms one extremity of the vane and/or is intended to delimit the vane along its height.

According to various advantageous embodiments of the invention, the airfoil of the vane is solid.

According to various advantageous embodiments of the invention, the upstream block occupies the cut-out in the frame.

According to various advantageous embodiments of the invention, the density of the frame is greater than that of the airfoil material, for example, at least 30% denser, e.g., at least 50% denser, in various instances, twice as dense.

A further object of the invention is a vane of an axial turbine engine, for instance of a compressor of a turbine engine, the vane including: a airfoil and a frame; the frame including: a base intended to be connected to a support of the turbine engine and an upstream portion extending from the base and forming a leading edge of the vane; wherein the frame further includes a stiffener enveloped by the airfoil of the vane so as to isolate the stiffener from the upstream portion, the stiffener extending, for example, from the base.

According to various advantageous embodiments of the invention, the vane includes a trailing edge, the stiffener being distanced, in various instances, along the chord of the vane, from the leading edge and the trailing edge.

The invention still further relates to a turbine engine, for example, an axial turbine engine, including a vane with a frame, wherein the frame conforms to the invention, and/or the vane conforms to the invention, the turbine engine, in various instances, includes a compressor with a vane conforming to the invention.

According to various advantageous embodiments of the invention, the turbine engine includes a rotor, the base of the vane being connected to the rotor, the base, in various instances, being welded to the rotor.

According to various advantageous embodiments of the invention, the turbine engine includes at least one annular row of vanes, the row of vanes including vanes conforming to the invention, and one-piece vanes in metal and/or one-piece vanes in composite material.

In a general manner, the advantageous embodiments of each object of the invention are also applicable to the other objects of the invention. As far as possible, each object of the invention can be combined with the other objects.

The arrangement of the invention offers a compromise between stiffness and lightness. It is based on the complementarity of the frame and of the airfoil, one being strong and the other being light. The airfoil is embedded in the frame while enveloping the central stiffener. The vane can be constructed like the sail of a boat: the airfoil becomes an airfoil stretched between the leading edge and the central stiffener. Consequently, the airfoil is held in the cut-out due to the branches of the frame; that is to say, the upstream portion and the stiffener; and due to its intrinsic stiffness. This stiffness is also used to advantage such that the airfoil preserves its camber downstream of the central stiffener.

The upstream portion and the stiffener form two pillars, which mutually support each other. In fact, their stiffness values are combined due to the airfoil, which forms a rigid link between them. Their different profiles furthermore have different stiffness values depending on the different torsion modes, so that joining them makes it possible to benefit from their complementary performances.

### DRAWINGS

FIG. 1 represents an axial turbine engine, according to various embodiments of the invention.

FIG. 2 is a diagram of a compressor of a turbine engine according to various embodiments of the invention.

FIG. 3 illustrates a vane with a frame according to various embodiments of the invention.

FIG. 4 shows a section of the vane according to various embodiments of the invention along the axis 4-4 traced in FIG. 3.

### DETAILED DESCRIPTION

In the description that will follow, the terms interior or internal and exterior or external refer to a positioning in relation to the axis of rotation of an axial turbine engine. The axial direction corresponds to the direction along the axis of rotation of the turbine engine. The radial direction is perpendicular to the axis of rotation. Upstream and downstream are with reference to the main direction of flow in the turbine engine.

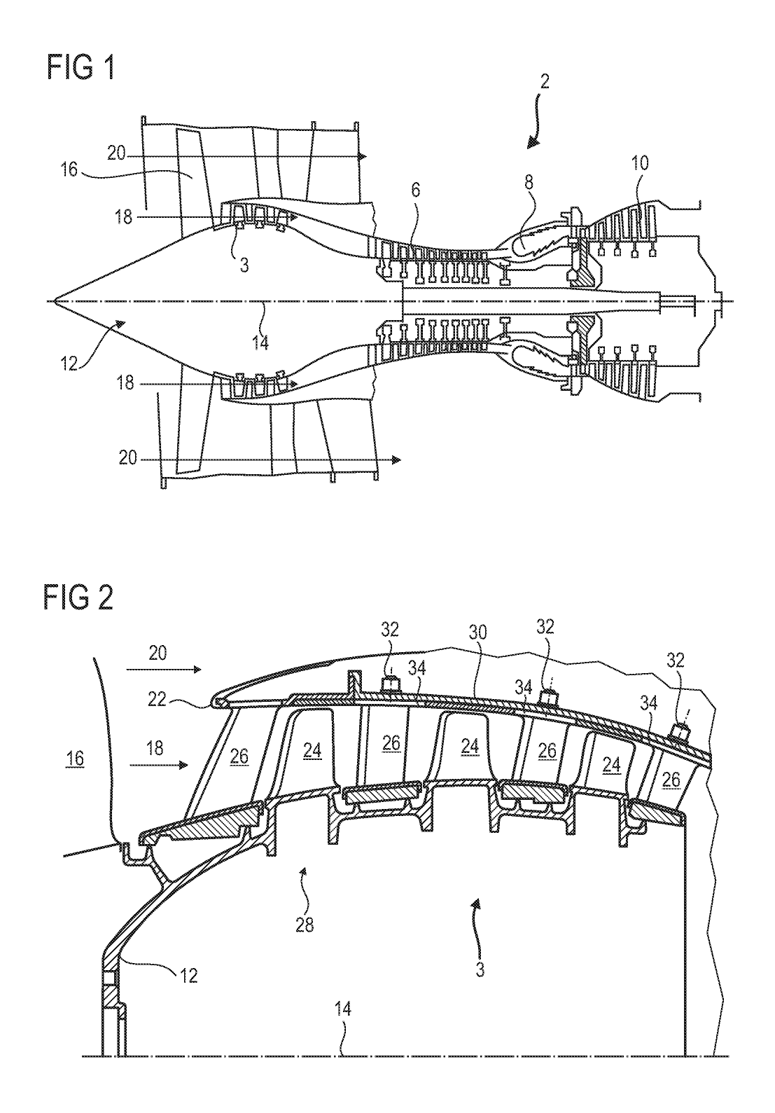

FIG. 1 represents an axial turbine engine 2 in a simplified manner. In this specific case, it is a turbofan. The turbofan 2 includes a first compression stage, called low pressure compressor 3, a second compression stage, called high pressure compressor 6, a combustion chamber 8 and one or more turbine stages 10. During functioning, the mechanical power of the turbine 10 transmitted via the central shaft to the rotor 12 sets the two compressors 3 and 6 in motion. These latter comprise several rows of rotor vanes associated with rows of stator vanes. The rotation of the rotor around its axis of rotation 14 thus makes it possible to generate an air flow and progressively to compress the latter up to the inlet to the combustion chamber 8. Demultiplication means can increase the speed of rotation transmitted to the compressors.

An inlet ventilator, commonly designated fan or blower 16 is coupled to the shaft/rotor 12 and generates an air flow, which splits into a primary flow 18 passing through the different abovementioned stages of the turbine engine, and a secondary flow 20 passing through an annular duct (partially represented) along the machine, then re-joining the primary flow at the turbine outlet. The secondary flow 20 can be accelerated so as to generate a thrust reaction. The primary 18 and secondary 20 flows are annular flows, they are channelled by the turbine engine casing. To that effect, the casing has cylindrical sides or shrouds, which can be internal and external.

FIG. 2 is a sectional view of a compressor of an axial turbine engine such as that of FIG. 1. The compressor can be a low pressure compressor 3. A part of the fan 16 and the nozzle 22 for separating the primary flow 18 and the secondary flow 20 can be observed there. The rotor 12 includes several rows of rotor vanes 24, three in this case. The rotor 12 is formed by a drum 28 supporting several rows of rotor vanes 24; alternatively, it can be formed by joining several discs supporting the vanes. The vanes can be welded to the drum 28, so that it forms a one-piece rotor 12.

The low pressure compressor 3 includes several guide vanes, four in this case, each containing a row of stator vanes 26. The guide vanes are associated with the fan 16 or with a row of rotor vanes 24 for guiding the air flow, so as to convert the speed of the flow to static pressure.

The stator vanes 26 extend essentially radially from an exterior casing 30, and can be fastened and immobilized there by means of pins 32. The latter can be those of fastening platforms 34 or fastening bases 34. The stator vanes 26 are evenly spaced from each other and have the same angular orientation in the flow 18.

The rotor 24 and/or stator 26 vanes can be composite. Each one can have a reinforcing frame and a airfoil combined with the frame. The rows of vanes (24, 26) can be mixed. Some vanes (24, 26) in the same row can have a frame and a airfoil of different materials, while other vanes (24, 26) in the row can be of the same material. Each reinforced vane (24, 26) can be produced by means of a metal frame onto which a composite airfoil is co-moulded, the frame then becoming a stiffening insert. The composite can include a preform in contact with the frame and an epoxy resin injected according to a RTM type of process. It can also be a mixture of short carbon fibres, for example, of a length less than 3 mm, and a matrix in polyetherimide (PEI) or PEEK, or any other equivalent matrix.

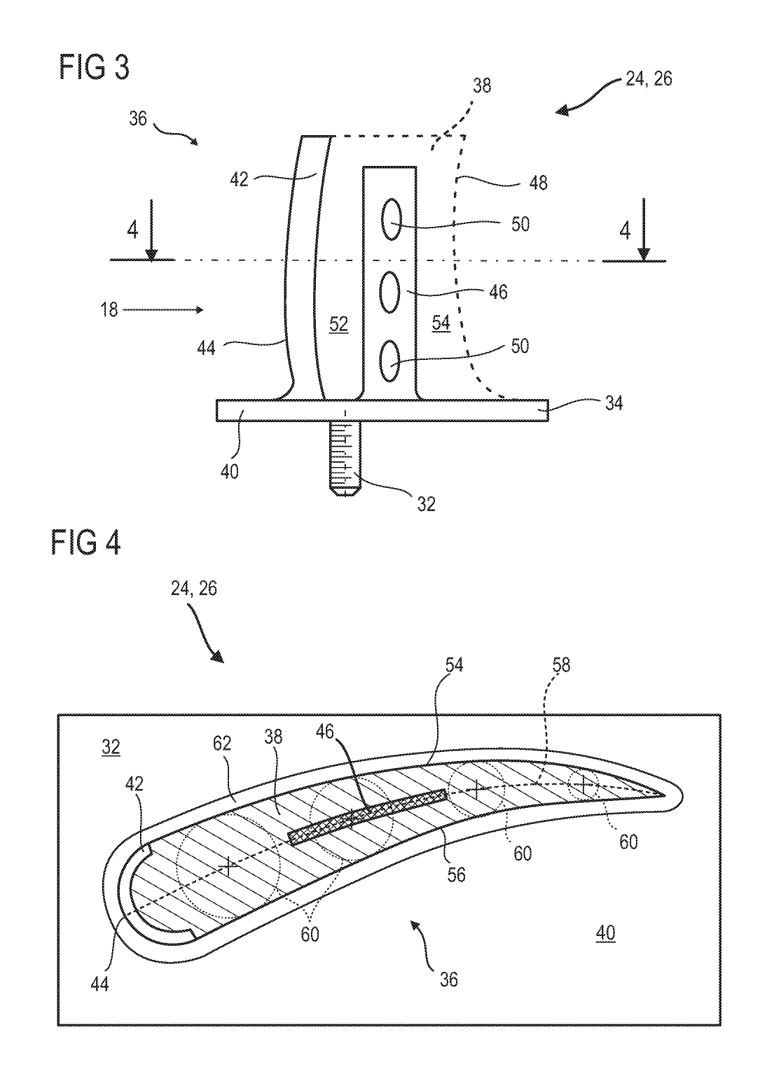

FIG. 3 represents a frame 36 of a vane (24, 26), seen in profile. The contour of the airfoil 38 of the vane (24, 26) is represented by dotted lines. The airfoil 38 can be understood to be the aerodynamic portion of the vane (24, 26), and extends into the flow 18 of the turbine engine, so as to divert it according to the circumference. This makes it possible to compress the flow within the framework of a rotor vane 24 of FIG. 2, or to guide it in the case of a stator vane 26 of FIG. 2.

In various embodiments, the frame 36 of the vane (24, 26) is one-piece. It has several contiguous or branching portions, including a vane base 40, an upstream portion 42 forming the leading edge 44 of the vane (24, 26) and a stiffener 46. The frame 36 can be produced by welding, that is by welding the base 40 to the other two parts. Or else, the frame 36 can be moulded or produced by additive manufacturing with a metal base. By making a cut, it is possible to recognize the different layers of added material, whether in the shape of a powder or wire. The added crystals can be recognized.

The base 40 can be or can include a platform 34 for a vane (24, 26), the platform being intended to be connected to a support. It can be fastened by means of a fastening portion 32, such as a threaded pin 32 in the manner presented in FIG. 2. The base 40 can essentially be of a constant thickness, and links the upstream portion 42 to the stiffener 46. This configuration is advantageous for creating a stator guide vane 26. According to various alternative embodiments, the fastening portion 32 can be a dovetail intended to be inserted in an annular groove of a rotor (not represented). The base 40 forms the junction between the upstream portion 42 and the stiffener 46.

The base 40 can have a leading edge portion and a trailing edge portion. The base 40 can form a block of material capable of being fastened to its support by welding. This base 40 can be welded by electron beam welding into an opening of a metal external casing (not represented), or welded by orbital friction welding to a stump of a rotor (not represented).

The upstream portion 42 extends along the entire height of the airfoil 38 of the vane (24, 26) to protect it from ingestions along its entire height. The line of its leading edge 44 can form a curve in the space. It can describe an “S” and/or a helical shape. The line can generally be tilted according to the circumference. The upstream portion 42 extends along a minor fraction of the length of the airfoil 38, for example, along less than 25%.

The stiffener 46 generally forms a reinforcing strip, which extends along the majority of the height of the vane (24, 26) and/or of the leading edge 44. It extends along substantially the entire height of the airfoil 38, nevertheless remaining set back from its summit in order to economize on material. However, it can be envisaged that it extends beyond in order to form a fastening portion in the extension of the airfoil 38, for example in order to receive a shroud. The stiffener 46 forms a backbone inside the airfoil 38. By its presence, it increases the stiffness of the airfoil 38 and limits deformations thereof linked with the flow 18 and/or the centrifugal force.

The stiffener 46 can have a strip shape, in various instances, rectangular. Its edges can be matched to the contour of the leading edge 44 and that of the trailing edge in order to optimize the material used. One edge can have a sinusoidal shape. The stiffener 46 can be penetrated by several orifices 50, radially distributed, which makes it possible both to lighten it and to improve anchoring between the frame 36 and the body of the airfoil 38.

The stiffener 46 is placed between, and distanced from, the leading edge 44 and the trailing edge 48. It is placed in a central zone of the base 40, measured along the direction of the flow 18. The central aspect can be understood as being distanced from the upstream and downstream extremities. The center of the base 40 can be at the level of the stiffener 46. In the central position, the stiffener 46 makes it possible to hold both the upstream part and the downstream part of the airfoil 38, which allows its action to be shared. However, it is not indispensable for it to be precisely in the center, since the performance and the strength of the vane (24, 26) are based on the variable forces generated by the flow 18, and since the airfoil 38 moreover benefits from being held upstream of the upstream portion 42. The person skilled in the art will be able freely to adapt the position of the stiffener 46 according to its stresses, just as well as he/she will be able to adjust its geometry.

The frame 36 has a cut-out 52, possibly a central cut-out 52. It is formed between the upstream portion 42 and the stiffener 46. The cut-out 52 forms a clear area, a separation, between the upstream portion 42 and the stiffener 46. There, it creates a breach in the profile of the frame 36. This cut-out 52 adheres to the logic of economy of material. This cut-out 52 makes it possible to create a continuous section where the strength of the airfoil resides essentially in its actual material. The fastening portion 32 can be placed at the cut-out 52, and/or at the stiffener 46. This configuration makes it possible to stiffen the junction formed by the base 40. The expression “at” can be according to the direction of the flow, for example, of the primary flow 18.

The frame 36 can also display a downstream cut-out 54, between the stiffener and the trailing edge 48. This zone is advantageously filled by the material of the body of the airfoil 38. De facto, the section of the airfoil 38 forming the trailing edge 48 benefits from the stiffness of the stiffener 46, while at the same time remaining light.

FIG. 4 represents a section of the vane (24, 26) at the axis 4-4 traced in FIG. 3. Once again, it can be a rotor vane 24 or a stator vane 26 such as those illustrated in FIG. 2 then in FIG. 3.

The upstream portion 42 can be generally profiled. It can form a shield, a plating. It can display a sheet shape. It can have a general trough shape. Its profile can be arched or curved. This profile can have two flanks, one on the extrados side 54, the other on the intrados side 56. The leading edge 44 of the vane (24, 26) can be on an upstream face of the upstream portion 42. The downstream face of the profile describes a groove, which is covered by the body of the airfoil 38. This face can be lined with asperities, such as cavities or barbs in order to improve the anchoring of the airfoil 38. The person skilled in the art is moreover encouraged to optimize the upstream portion 42 in order to tend to the embedded installation of the airfoil 38. The same approach applies to the stiffener 46 of the frame 36.

The profile of the vane (24, 26) is mainly formed by the body of the airfoil 38; in various instances the frame 36 fills a minor part, for example, less than or equal to 25%, e.g., less than or equal to 10% of the surface of the profile. This can be applied to any profile of the vane (24, 26). The stiffener 46 is implanted at the core of this airfoil 38, distanced from the intrados surface 56 and from the extrados surface 54. Its thickness is less than half the mean thickness of the airfoil 38. It is isolated from the flow, and so the intrados surface 56 and the extrados surface 54 are essentially smooth for an improved flow. The profile of the stiffener 46 can be generally rectangular, in various instances, substantially curved. This allows it to follow the curve of the airfoil 38, and also to display an increased stiffness against a tilting of the extremity of the airfoil 38. This action is therefore complementary to the shape of the upstream portion 42.

The body of the airfoil 38 is formed by a stack of aerodynamic profiles, one of which is represented here in section. Each aerodynamic profile comprises a mean camber line 58, this line 58 being formed by the joining of the centres of the circles inscribed as 60 in the profile. Advantageously, the mean camber lines 58 or the majority of the mean camber lines 58 passes or pass inside the stiffener 46; passing through it. The stiffness of the arrangement is thus increased with a reduced weight.

In various instances, the base 40 displays a rectangular platform shape, however, any other shape can be envisaged. The junction between the airfoil 38 and the base 40 has a peripheral connecting radius 62 forming a transition between the platform 32 and a vane profile. Naturally, the base can be delimited only by the connecting radius 62. In this case, the base can be a vane root in the shape of a vane profile with an inwardly curved intrados side and an outwardly curved extrados side.

What is claimed is:

1. A turbine engine vane frame, wherein the vane includes a leading edge structured and operable to split a flow within the turbine engine, said frame being one-piece and comprising:
a vane base structured and operable to be connected to a support of the turbine engine;
an upstream portion projecting from the base and forming the leading edge of the vane;
a stiffener generally situated at an axially central position of the base; and
a cut-out that separates the upstream portion from the stiffener and that extends from the base along the height of the stiffener.

2. The vane frame of claim 1, wherein the stiffener extends from the base along the majority of the height of the upstream portion.

3. The vane frame of claim 1, wherein the stiffener has a plurality of through-orifices, the orifices being distributed along its height.

4. The vane frame of claim 1, wherein the stiffener forms a strip having a constant width.

5. The vane frame of claim 1, wherein the cut-out extends axially from the upstream portion to the stiffener.

6. The vane frame of claim 1, wherein the base includes an aerodynamic vane profile, the profile being cambered.

7. The vane frame of claim 1, wherein the base includes a fastening platform that includes a fastening portion extending from the base opposite to the stiffener along the radial direction of the turbine engine.

8. The vane frame of claim 1, wherein the base has a downstream extremity, the stiffener being distanced from the downstream extremity.

9. The vane frame of claim 1, wherein it is produced from metal by additive manufacturing based on metal powder.

10. A turbine engine vane, said vane comprising:
a frame; and
a body, wherein the frame is a one-piece frame and comprises:
a vane base structured and operable to be connected to a support of the turbine engine;
an upstream portion extending from the base and forming the leading edge of the vane;
a stiffener surrounded by the body and generally situated at a central position of the base; and
a cut-out that axially separates the upstream portion from the stiffener and that extends from the base along the majority of the height of the vane.

11. The turbine engine vane of claim 10, wherein the frame is integral and comprises an integral interface forming successively the upstream portion, the vane base, and the stiffener.

12. The turbine engine vane of claim 10, wherein the body comprises a composite material with an organic matrix.

13. The turbine engine vane of claim 10, further including a trailing edge, an intrados surface and an extrados surface, that extend from the leading edge to the trailing edge, the body including an envelope forming the intrados surface and the extrados surface, the trailing edge being formed by the body.

14. The turbine engine vane of claim 10, wherein the body forms an upstream block isolating the upstream portion from the stiffener, the block being continuous along the entire height of the airfoil.

15. The turbine engine vane of claim 10, wherein the upstream portion has a groove turned towards the stiffener, the groove being filled by the body.

16. The turbine engine vane of claim 10, wherein the upstream portion forms a foil of a constant thickness, the foil having an upstream face forming the leading edge of the vane, and a downstream face covered by the body.

17. The turbine engine vane of claim 10, further including a trailing edge, the body forms a downstream block isolating the trailing edge from the stiffener, the block being continuous along the entire length of the trailing edge.

18. The turbine engine vane of claim 10, wherein the body has a radial stack of vane aerodynamic profiles with mean camber lines, at least one or each of the mean camber lines being placed in the thickness of the stiffener.

19. A turbine engine, said engine comprising:
a support; and
a vane with a frame, wherein the vane includes a leading edge structured and operable to split a flow within the turbine engine, and the frame is a one-piece frame and comprises:
a vane base connected to the support of the turbine engine,
an upstream portion extending from the base and forming the leading edge of the vane;
a stiffener generally situated at a central position of the base, and
a cut-out that axially separates the upstream portion from the stiffener and that extends from the base along the majority of height of the leading edge of the vane.

20. The turbine engine of claim 19, further including a rotor, the base of the vane being one of connected to the rotor, and welded to the rotor.
